(19) United States
(12) Patent Application Publication
(10) Pub. No.: US 2016/0336567 A1
(43) Pub. Date: Nov. 17, 2016

(54) ASSEMBLY FOR STORING ELECTRICAL ENERGY, AND ASSOCIATED PRODUCTION METHOD

(71) Applicant: BLUE SOLUTIONS, Ergue Gaberic (FR)

(72) Inventor: Erwan VIGNERAS, Quimper (FR)

(21) Appl. No.: 15/110,387

(22) PCT Filed: Jan. 6, 2015
(86) PCT No.: PCT/EP2015/050119

§ 371 Date: Jul. 7, 2016

(30) Foreign Application Priority Data
Jan. 7, 2014 (FR) 1450100

(51) Int. Cl. H01M 2/16; H01G 11/76; H01M 2/26; H01M 10/04; H01M 2/02; H01G 11/72; H01G 11/86

(52) U.S. Cl. CPC H01M 2/1653; H01G 11/72; H01G 11/76; H01G 11/86; H01M 10/0431; H01M 2/022; H01M 2/263; H01M 2/024

(57) ABSTRACT

The invention relates to an assembly for storing electrical energy (10) comprising a storage element (16) comprising at least one elementary cell (18) comprising first and second electrode complexes (19, 20) stacked in a stacking direction (21), said elementary cell further comprising a first separator (26) made of a plastic material extending between the first and second electrode complexes, and an outer shell (11) receiving the storage element (16), the shell comprising two separate surfaces (15, 14) forming electrical terminals of the assembly having opposite polarities, the one or more first complexes (19) being electrically connected to a first terminal (15) and the one or more second complexes (20) being electrically connected to a second terminal (14), in which the element comprises at least one additional layer (29, 30) extending at least at one end (31, 32) of the storage element in the stacking direction, each additional layer being made up of a component identical to one of the components of the elementary cell (18), none of the additional layers of a single end of the storage element being connected to the terminal having the opposite polarity to the terminal to which the electrode complex adjacent to said additional layers is connected.

### GENERAL TECHNICAL FIELD

The present invention relates to an electrical energy storage assembly, and a method for producing such an assembly.

More particularly, the present invention relates to an energy storage assembly including a separator layer made of plastic material.

### PRIOR ART

Electrical energy storage elements are known from the prior art, such as supercapacitors or batteries.

Such an electrical energy storage element includes generally two electrodes with opposite polarities, porous and impregnated with electrolyte, between which is positioned a porous insulating layer called a “separator.” The separator layer makes it possible to insulate the electrodes from one another so as to avoid short-circuits, while ensuring ionic conductivity between the electrodes.

In a supercapacitor, the ions are displaced under the influence of an electric field toward or from the surface of the electrodes depending on the state of charge or discharge of the supercapacitor.

In a battery, the ions are displaced from one electrode to the other depending on the state of charge or discharge of the battery under the influence of chemical reactions operating at each of the electrodes.

The use of separators made of plastic material is often preferred to the use of separators made of paper. In fact, the use of such separators made of polymer makes it possible not only to obtain a storage element having better resistance to aging, but also to use the storage element at a higher electrical voltage. In addition, the use of such separators makes it possible to reduce the risks of perforation of said separators which can result in electrical contact of two adjoining electrodes of opposite polarity, and therefore a short-circuit in the storage element, and also to reduce the costs of manufacture of a storage element.

The storage elements as described above are generally placed in a rigid external envelope including a case and at least one cover closing the case so as form a storage assembly.

However, the manufacture of a storage assembly as previously described requires several heating steps likely to raise the storage element to elevated temperatures. Such steps are for example the step of polymerizing the glue used to connect the cover and the case forming the envelope accommodating the storage element, the step of dehydrating the storage element so as to reduce the impurities present in the electrolyte with which the electrodes are impregnated, or the step of welding allowing each of the electrodes to be connected to the terminals of the envelope accommodating the storage element, during which the storage element can be heated up to temperatures of roughly 180° C.

These heating steps often result in an increase in the temperature of the separator by thermal conduction, and it can happen that this temperature reaches a value that causes a deformation of the separator called “shrinking,” due to the considerable porosity of the separator, and tending to uncover the electrodes at their ends. In fact, the temperature where the polymer separator undergoes strong shrinking occurs in proximity to 130° C., particularly when the separator is made of polypropylene. Such shrinking of the separator is a particular problem in that it can lead to electrical contact between two adjoining electrodes of opposite polarity, and therefore to a short-circuit in the storage element.

### PRESENTATION OF THE INVENTION

One aim of the present invention is therefore to propose an electrical energy storage assembly comprising at least one separator layer made of plastic material making it possible to avoid shrinking of the separator in the case where the storage element is heated, while still retaining the advantages linked to the use of the separator made of plastic material.

More precisely, the invention has as its object an electrical energy storage assembly including:
an electrical energy storage element comprising at least one elementary cell comprising a first and a second electrode complex stacked in a stacking direction, said elementary cell further comprising a first separator made of plastic material particularly of polypropylene, extending between the first and the second electrode complex,
an external envelope accommodating the storage element, the envelope including two distinct surfaces forming electrical terminals of the assembly and having opposite polarity, the first complex(es) being electrically connected to a first terminal and the second complex(es) being electrically connected to a second terminal,
   the assembly being characterized in that the element includes at least one additional layer extending to at least one end of the storage element in the stacking direction, each additional layer consisting of a component identical to one of the components of the elementary cell, none of the additional layers of a same end of the storage element being connected to the terminal of polarity opposite to the terminal to which the electrode complex adjoining said additional layers is connected.

It was in fact realized that the problem of shrinking stated above occurred especially at the ends of the storage element, the separators located in the core of the storage element being intact or slightly affected by this problem because they are insulated from the outside by the electrode complexes between which they are placed. By placing one or more additional layers that are not at risk of entering into a short-circuit with the electrode complexes that make it possible to store energy (those of the elementary cells), the separator of each elementary cell is thus better insulated from the outside, even those situated in the elementary cells at the ends, and the shrinking of the separator of the elementary cells is thus prevented: the additional layer(s) serve(s) in fact as thermal screen(s) and allow, through their presence, a reduction in the quantity of heat transmitted to the separator of the elementary cell closest to the end of the pile.

Thus it is possible to use the method for producing the storage assembly of the prior art without noticeably modifying it and the adaptation carried out is neither very expensive (additional layers which are already available are added and are therefore not specifically manufactured for the purpose) nor very complex to implement.

With an assembly according to the invention, it is even possible if necessary to use higher temperatures than those of the prior art during production of the assembly, depending on need, thus reducing the time and potentially the cost of the production method. The assembly also makes it possible to enlarge the field of polymers which can be used as separators, the melting temperature no longer being as strong a constraint, to use the polymer whose properties are optimal relative to the use desired.

Thanks to the invention, it is thus possible to produce a functional energy storage assembly with a separator made of plastic material and using a simple and low cost method, without needing to adapt the method or the mechanical parts (envelope, etc.) already used to make the assembly.

According to one embodiment of the invention, the or at least one additional layer includes an electrode. The porosity of the electrode makes it possible in fact to capture air in large quantity and thus to realize a very effective thermal screen.

According to one embodiment of the invention, the or at least one of the elementary cells is provided with at least one collector making it possible to connect an electrode complex of the cell to the corresponding terminal, the or at least one of the additional layers including a collector. The collector can be part of the electrode complex, but it can also be an independent component of the electrode.

In particular, the or at least one of the additional layers is an electrode complex including at least one electrode and a collector in one single piece.

According to one embodiment of the invention, the or at least one of the additional layers includes a separator made of plastic material, the additional layers then having a low cost.

According to one embodiment of the invention, the storage element comprises at one of its ends at least, three adjoining additional layers formed from two layers including an electrode between which is interposed a separator layer.

According to one embodiment of the invention, at one end of the element at least, at least one additional layer including an electrode is connected to the terminal of the same polarity as the electrode complex adjoining the additional layers of said end. In this case, in fact, there is no risk of a short circuit.

According to one embodiment of the invention, an additional layer of one of the ends is connected neither to the first nor to the second terminal, whether the additional layer is of the separator, collector or electrode type. Therefore, there is no risk of short circuit.

According to one embodiment of the invention, the components of the elementary cell(s) form piled planar layers, the additional layer(s) being placed at one and/or the other of the ends of the pile.

According to another embodiment of the invention, the components of the elementary cell(s) are coiled up, so that the same component forms a plurality of layers of the coiling and the element is of generally cylindrical shape, the additional layer(s) being placed inside and/or outside the coiling.

The additional layer located farthest within the coil is a layer including an electrode and/or a collector, which makes it possible to avoid having the layer located farthest inside the coil sticking to the coiling spindle, as would have been the case if this layer had been a separator made of plastic material.

In particular, at least one of the additional layers is made using a component also forming at least one layer of the or of at least one of the elementary cells, which makes it possible to form additional layers very simply and economically. This configuration is particularly applicable when the element is coiled.

According to one embodiment of the invention, the envelope comprises a case and at least one cover closing the case, the surfaces forming terminals being positioned on two distinct parts, the parts being preferably connected through an electrically insulating joint.

The embodiments previously described can be combined advantageously.

The invention also has as its purpose a manufacturing method for an electrical energy storage assembly, particularly so as to form an assembly as previously described, comprising the steps of:
stacking a first electrode complex, a first separator, and a second electrode complex in a stacking direction, so as to form an elementary cell;
constructing the storage element based on at least one elementary cell and at least one additional layer consisting of a component identical to one of the components of the elementary cell, so that the additional layer(s) are placed at the end of the storage element;
installing the storage element in an external envelope and connecting electrically the storage element to electrical terminals of opposite polarity of the storage assembly, formed by two distinct surfaces of the envelope, so that the first complex(es) is(are) electrically connected to a first terminal and the second complex(es) is(are) connected to a second terminal and none of the additional layers located at one end of the storage element is connected to the terminal of polarity opposite to the terminal of polarity to which the electrode complex adjoining said additional layers is connected.

It will be noted that, during the step of making the storage assembly, it is possible to first install the different elementary cells, then add the additional layers to the end(s) of the stack. Alternatively, it is possible to first install the additional layers, at least at one end of the stack, before installing the components of the elementary cells. The additional layers and the elementary cells could also be formed simultaneously.

According to a first embodiment of the invention, the method comprises the steps of:
stacking of a second separator on the second electrode complex in the stacking direction, so as to form an elementary sequence;
coiling the elementary sequence around a coiling axis, so that the storage element has the shape of a coil.

According to a first embodiment of the invention, a portion of the components of the elementary sequence is preferably coiled alone around the coiling axis, so as to form a core of at least one additional layer around which the elementary sequence is then coiled. Advantageously, said or one of said components comprises an electrode. Advantageously, the first electrode complex and the first separator are coiled alone around the coiling axis, so as to form the core of at least one additional layer.

According to the first embodiment of the invention, at the other end of the element, a portion of the components of the elementary sequence is coiled alone around the coiling axis, so as to wrap with at least one additional layer the coil comprising the elementary sequence. Advantageously, the second electrode complex and the second separator layer are coiled alone around the coiling axis so as to wrap the coil with at least one additional layer.

According to a second embodiment of the invention, the method comprises the steps of:
stacking a second separator on the second electrode complex in a piling direction coinciding with the stacking direction, so as to form an elementary sequence;
piling several elementary sequences in the piling direction;
piling at least one additional layer with at least one elementary sequence, so that the additional layer(s) is(are) located at one end at least of the pile previously formed in the piling direction.

### PRESENTATION OF THE FIGURES

Other features, aims and advantages of the invention will be revealed by the description that follows, which is purely illustrative and not limiting, and must be read with reference to the appended drawings, wherein:

FIG. 1 shows an exploded view of an electrical energy storage assembly comprising an energy storage element according to one embodiment of the invention wherein the storage element is said to be “coiled”;

FIG. 2 shows a schematic view of an elementary sequence of an electrical energy storage element;

FIG. 3 shows a schematic sectional view of the coiled storage element presented in FIG. 1;

FIG. 4 shows a schematic view of an electrical energy storage element according to a different embodiment of the invention from that presented in FIGS. 1 and 3, wherein the storage element is said to be “stacked.”

### DETAILED DESCRIPTION

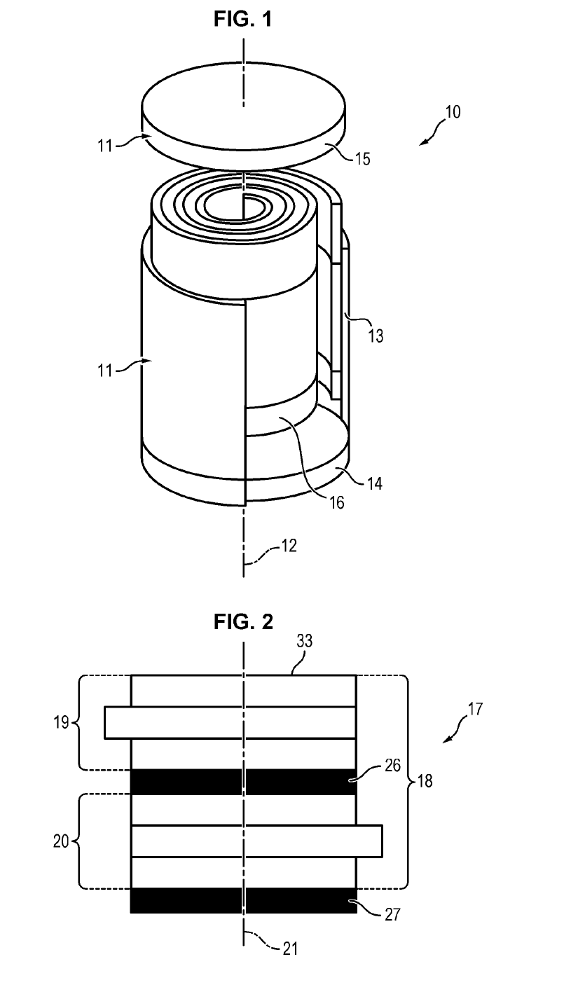

FIG. 1 shows an electrical energy storage assembly 10 according to one embodiment of the invention.

The storage assembly 10 includes an external envelope 11. In the example shown in FIG. 1, the external envelope 11 is substantially cylindrical and extends along a longitudinal axis 12. The external envelope 11 includes a case 13 provided with a side wall and a bottom 14 positioned at a first end of the case 13 along the longitudinal axis 12 and open at a second end opposite to the bottom 14. The external envelope 11 further includes a cover 15 applied to the second end of the case 13 so as to close the open end of the case 13. The cover 15 is for example glued to the cover 13. In the example shown in FIG. 1, the cover 15 and the bottom 14 each form terminals of opposite polarity of the storage assembly 10. According to one variant, the external envelope 11 includes a case provided with a side wall and two covers each applied to one of the open ends of the case 13 along the longitudinal axis 12, and each forming a terminal of opposite polarity.

The external envelope 11 accommodates an electrical energy storage element 16, for example a supercapacitor or a battery. In the example shown in FIG. 1, the storage element 16 forms a coil. It is said to be “coiled.”

The storage element 16 comprises an elementary sequence 17 shown in FIG. 2.

The elementary sequence 17 comprises an elementary cell 18. The elementary cell 18 includes a first electrode complex 19 and a second electrode complex 20 stacked one on top of the other in a stacking direction 21.

In the example shown in FIG. 2, the first and second electrode complexes 19 and 20 each include two electrodes 22 and 23, between which an electric current collector 24 and 25 is interposed. The electrodes 22 and 23 and the collector 24 or 25 are in one single piece.

According to one variant (not shown), the first and second electrode complexes include a single electrode and/or a single electrode with a current collector. In the case where the first and second complexes comprise a single electrode, the elementary cell can comprise a collector layer supplementing the electrode complex.

It will be noted that electrode complexes 19 and 20 are described here that are identical to the two terminals of the elementary cell 18, but that the elementary cell 18 could just as easily be built asymmetrically, including for example a first or a second electrode complex 19 or 20 as previously described and a second or a first electrode complex 20 or 19 having a single electrode and a collector layer, or having another architecture.

The electrodes 22 and 23 are porous and impregnated with electrolyte. The electrodes 22 and 23 are for example mainly constructed of active carbon.

The first electrode complex 19 forms a first assembly of a first polarity connected to a first electrical terminal by means of a collector 24. The first terminal is for example formed by the cover 15 of the external envelope 11.

The second electrode complex 20 forms a second assembly of a second polarity connected to a second electrical terminal by means of the collector 25. The second terminal has polarity opposite to that of the first terminal. The second terminal is for example formed by the bottom 14 of the external envelope 11.

The elementary cell 18 further includes a first separator 26 positioned between the first electrode complex 19 and the second electrode complex 20. The first separator 26 is made of plastic material, for example of polypropylene, and electrically insulates the first and second electrode complexes 19 and 20 from one another, so as to avoid the generation of a short circuit in the storage element 16. The first separator 26 is porous so as to allow ionic conduction between the first and second electrode complexes 19 and 20.

The elementary sequence 17 further includes a second separator 27 stacked on the second electrode complex 20 of the elementary cell 18 in the stacking direction 21.

The elementary sequence 17 is coiled on itself around a coiling axis 28, so as to form the coil. The coiling axis 28 coincides with the longitudinal axis 12 when the storage element 16 is placed within the external envelope 11. All the layers of the coil which are of the same type are therefore in one single piece, consisting respectively of the same component of the elementary sequence. In other words, all the layers comprising the first electrode complex 19 are in one single piece, and all the layers comprising the second electrode complex 20 are in one single piece. Likewise, all the layers comprising the first separator 26 are in one single piece, and all the layers comprising the second separator 27 are in one single piece.

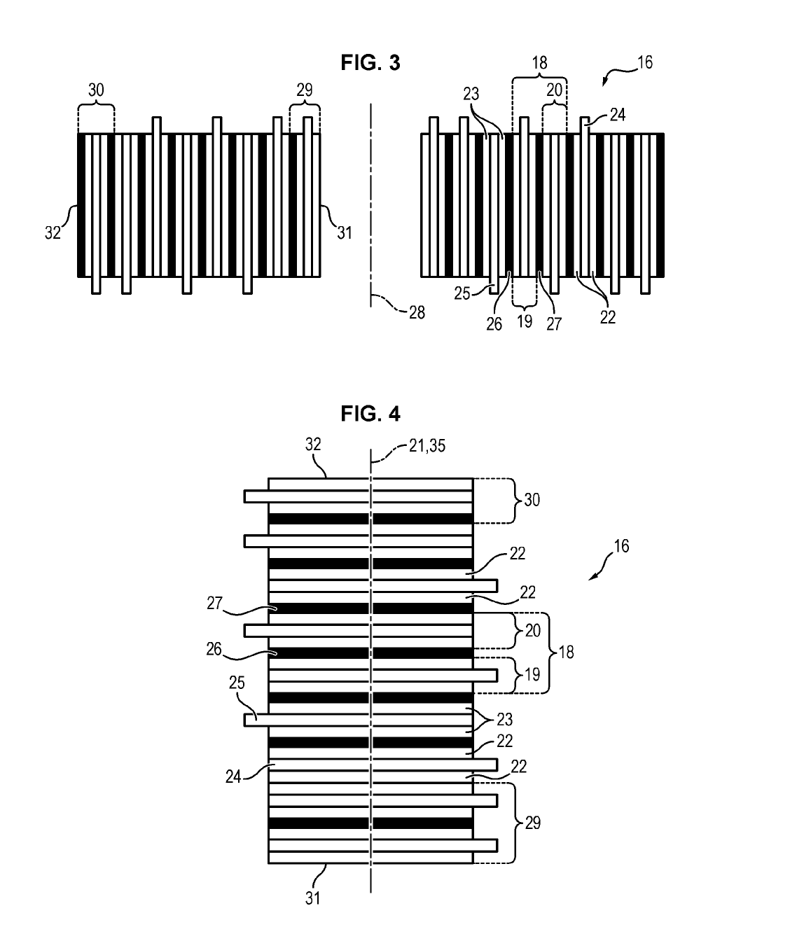

A sectional view of the coil is shown schematically in FIG. 3.

As illustrated in FIG. 3, when the elementary sequence 17 is coiled, the first electrode complex 19 interacts with the second electrode complex 20 of the same coil turn n, but also with the second electrode complex 20 of the coil turn n−1. Likewise, the second electrode complex 20 interacts with the first electrode complex 19 of the same coil turn n, but also with the first electrode complex 19 of the coil turn n+1.

The collector 24 of the first electrode complex 19 and the collector 25 of the second electrode complex 20 protrude with respect to the electrode layers 22 and 23 in opposite directions along the coiling axis 28. In this manner, the collector 24 of the first electrode complex 19 protrudes toward the first terminal 15 and the collector 25 of the second electrode complex 20 protrudes toward the second terminal 14, when the storage element 16 is positioned inside the external envelope 11. Thus, the connection of the collectors 24 and 25 to their respective terminal is facilitated.

The storage element 16 also comprises additional layers 29 and 30, respectively at each of the ends 31 and 32 of the storage element 16 in a radial direction. At a first radial end 31 positioned inside the coil, the additional layers 29 are coiled over themselves around the coiling axis 28, so as to form a core around which the elementary sequence 17 is coiled. At a second radial end 32 positioned outside the coil, the additional layers 30 are coiled around the coil along the coiling axis 28, so as to wrap it.

Each additional layer 29 and 30 consists of a component identical to one of the components of the elementary cell 18. In other words, each additional layer 29 and 30 is selected from among the following components:
a single electrode,
an electric current collector,
a single electrode and an electric current collector,
an electrode complex comprising two electrodes between which an electric current collector is interposed,
a separator made of plastic material.

Thus, the additional layers 29 and 30 are selected from among the components already available for producing the storage element 16.

The storage element 16 can comprise additional layers 29 and 30 identical to one another or different at each radial end 31 and 32.

The storage element 16 can comprise an equal number or a different number of additional layers 29 and 30 at each radial end 31 and 32.

The storage element 16 can also comprise additional layers 29 or 30 at only one of its radial ends 31 or 32.

In the example of FIG. 3, certain of the additional layers 29 and 30 of the radial ends 31 and 32 consist of an electrode complex comprising two electrode layers between which a current collector is interposed. Due to the porosity of the electrodes, which therefore comprise much air, the electrode complexes constitute particularly effective thermal screens. The collectors being already assembled with the electrodes prior to the formation of elementary cells, the entire electrode complex is used to form the additional layers 29 and 30. In the example of FIG. 3, other additional layers 29 and 30 consist of a separator, which is a low-cost material.

In the example shown in FIG. 3, the storage element 16 comprises at the first radial end 31 two additional layers 29, which are, from the first radial end 31 toward the second radial end 32, an electrode complex and a separator made of plastic material. The storage element 16 comprises at the second radial end 32 three additional layers 30, which are two separator layers made of plastic material between which an electrode complex is interposed.

None of the additional layers 29 and 30 of the same radial end 31 and 32 is connected to the assembly of polarity opposite to the assembly of polarity to which is connected the electrode complex 19 or 20 of the elementary cell 18 adjacent to said additional layers.

In the example shown in FIG. 3, at the first radial end 31, the additional layers 29 are adjacent to the first electrode complex 19 connected to the first terminal 15. Thus, the additional layers 29 of the first radial end 31 cannot be connected to the second terminal 14. Likewise, at the second radial end 32, the additional layers 30 are adjacent to the second electrode complex 20 connected to the second terminal 14. Thus the additional layers 30 of the second radial end 32 cannot be connected to the first terminal 15.

In this manner, there cannot be any short-circuits between the additional layers 29 and 30 of a same radial end 31 or 32 or between the additional layers 29 and 30 and the electrode complexes 19 and 20 of the elementary cell 18 adjoining said additional layers. Moreover, there also cannot be such short-circuits in the event of heating the storage element 16 or shrinking of the additional layers 29 and 30 made of plastic material. What is meant by “shrinking” is a deformation of the separator layers 26 and 27 made of plastic material tending to uncover the layers of electrode 22 and 23 at their ends along the coiling axis 28, and possibly leading to electrical contact between the two adjoining electrode layers 22 and 23 of opposite polarity, and thus to a short circuit in the storage element 16.

Moreover, the additional layers 29 and 30 form a thermal screen making it possible to limit, in the event of heating the storage element 16, shrinking of the separator layers 26 and 27 made of plastic material of the different elementary cells 18, and therefore to reduce the risks of short-circuits in the storage element 16.

According to a first embodiment, an additional layer 29 or 30 of one radial end 31 or 32 is connected to the terminal with the same polarity as the electrode complex 19 or 20 of the elementary cell adjoining said additional layers. According to a second embodiment, an additional layer 29 and 30 of a radial end 31 or 32 is connected neither to the first terminal 15 nor to the second terminal 14.

That this is in fact the case is ensured by forming the electrode complexes constituting the additional layers 29 or 30 so that the collector protrudes on the same side as the collector 24 or 25 of the electrode complex 19 or 20 belonging to the elementary cell 18 and adjoining the additional layers 29 or 30. For this reason, it cannot be connected to the terminal of opposite polarity, even by mistake.

Alternatively, one can carry out a step in treating the electrode complex of the additional layer 29 or 30 during which the portion of the collector which protrudes from the electrode is cut out so as to avoid any risk of contact with one of the two terminals 14 or 15.

The production of the coiled storage element 16 occurs according to the following method.

During a first step, the first electrode complex 19 and the first separator 26 are stacked in the stacking direction 21.

During a second step, they are coiled alone, over at least one turn, around the coiling axis 28, so as to form a core comprising at least one additional layer 29. The core is for example coiled around a spindle.

Preferably, the additional layer 29 closest to the first radial end 31 comprises an electrode, so that the additional layer 29 cannot stick to the coiling spindle, as can be the case if the additional layer 29 is a separator made of plastic material.

In the example shown in FIG. 3, the first electrode complex 19 and the first separator 26 are selected to form the additional layers 29 of the first radial end 31. The first electrode complex 19 and the first separator layer 26 alone are coiled around the coiling axis 28 for one turn.

Then, during a third step, the second electrode complex 20 and the second separator 27 are piled on the first separator 26, already coiled to form the core, in the stacking direction 21, so as to form the elementary sequence 17.

During a fourth step, all the layers of the elementary sequence 17 are coiled together around the core, so as to form a coil.

During a fifth step, a portion of the components of the elementary sequence 17 closest to the first end 33 of the elementary sequence 17 in the stacking direction 21 is cut, that is the first electrode complex 19 and the first separator 26, while the other portion of the layers of the elementary sequence 17 is coiled alone, for at least one turn, around the coiling axis 28 so as to wrap the coil with at least one additional layer 30.

It will be noted that it is possible to cut the first separator 26 with an offset with respect to the first electrode complex 20, also cut before finishing coiling, so that it extends a few millimetres beyond the first electrode complex 20 so as to prevent short-circuits in the event of shrinking in a tangential direction relative to the coil.

In the example shown in FIG. 3, the second electrode complex 20 and the second separator 27 are selected to form the additional layers of the first radial end 31. The second electrode complex 20 and the second separator 27 are coiled alone around the coiling axis 28 for one turn.

Finally, during a sixth step, the storage element 16 is installed in the external envelope 11, and during a seventh step the storage element 16 is connected electrically to the first and to the second electrical terminal 15 and 14, so that the first electrode complex 19 is connected to the first terminal 15, the second electrode complex 20 is connected to the second terminal 14, and none of the additional layers 29 and 30, located at one radial end 31 and 32 of the storage element 16, is connected to the terminal 15 or 14 of polarity opposite to the terminal of polarity to which the electrode complex adjoining said additional layers 29 and 30 is connected.

FIG. 4 shows the storage element 16 according to another embodiment of the invention. In the example shown in FIG. 4, the storage element 16 is said to be “stacked.”

In the remainder of the description, only the elements which differ from the embodiment shown in FIGS. 1 and 3 will be detailed.

The storage element 16 includes a pile of several elementary sequences 17 in a piling direction 35. The piling direction 35 coincides with the stacking direction 21 when the elementary sequences 17 are piled.

As illustrated in FIG. 4, when the elementary sequences 17 are piled, the first electrode complex 19 of an elementary sequence 17 of a pile m interacts with the second electrode complex 20 of the elementary sequence 17 of the same pile m, but also with the second electrode complex 20 of the elementary sequence 17 of the pile m−1. Likewise, the second electrode complex 20 of an elementary sequence 17 of a pile m interacts with the first electrode complex 19 of the elementary sequence 17 of the same pile m, but also with the first electrode complex 19 of the elementary sequence 17 of the pile m+1.

The collector 24 of the first electrode complex 19 and the collector 25 of the second electrode complex 20 of each elementary sequence 17 protrude with respect to the electrode layers 22 and 23 in opposite directions, perpendicular to the stacking direction 21. In this manner, the collector 24 of the first electrode complex 19 protrudes toward the first terminal and the collector 25 of the second electrode complex 20 protrudes toward the second terminal, when the storage element 16 is positioned inside an external envelope. Thus, the connection of the collectors 24 and 25 to their respective terminals is facilitated.

The storage element 16 also comprises additional layers 29 and 30 respectively at each of the ends 31 and 32 of the pile in the piling direction 35.

In the example shown in FIG. 4, the storage element 16 comprises at the first end 31, in the piling direction 35, three additional layers 29 which are, from the first end 31 to the second end 32 in the stacking direction 35, an electrode complex, a separator made of plastic material and an electrode complex. The storage element 16 comprises at the second end 32, in the stacking direction 35, two additional layers 30 which are, from the second end 32 toward the first end 31 in the stacking direction 35, an electrode complex and a separator made of plastic material.

As previously described, the electrode complexes forming the additional layers 29 and 30 are arranged so that the collector protrudes on the same side as in the electrode complex 19 or 20 of the elementary cell 18 adjoining the additional layers 29 and 30. They can thus be connected to the same terminal 14 or 15 as said electrode complex of the elementary cell 18 or connected to neither of the terminals 14 or 15, but may not be connected to the terminal of opposite polarity, which makes it possible to avoid short circuits.

The production of the stacked storage element 16 takes place according to the following method.

During a first step, the first electrode complex 19, the first separator 26 and the second electrode complex 20 are piled in the piling direction 35 so as to form the elementary cell 18.

Then the second separator 27 is piled on the second electrode complex 20 in the piling direction 35, during a second step, so as to form the elementary sequence 17.

The first and second steps are repeated several times, so as to form a pile of several elementary sequences 17.

During a third step, one or more additional layers 29 and 30 are piled in the piling direction 35 at the first end 31 and/or the second end 32 in the piling direction 35.

According to a variant, the additional layers 29 of the first end 31 in the piling direction 35 are piled together prior to the first step. Then, during the first step, the first electrode complex 19, the first separator 26 and the second electrode complex 20 are piled in the piling direction 35 onto the additional layers 29 of the first end 31.

Finally, during a fourth step, the storage element 16 is installed in the external envelope 11, and during a fifth step, the storage element 16 is electrically connected to the first and to the second electrical terminal 15 and 14, so that the first electrode complexes 19 are connected to the first terminal 15, the second electrode complexes 20 are connected to the second terminal 14, and none of the additional layers 29 and 30 located at one end 31 and 32 of the storage element 16 are connected to the terminal 15 or 14 of polarity opposite to the terminal of polarity to which the electrode complex adjoining said additional layers 29 and 30 is connected.

The storage elements 16 previously described have the advantage of being provided with additional layers 29 and 30 which cannot form a short circuit either between themselves or with the electrode complex 19 or 20 of the elementary cell 18 adjoining said additional layers in the event of shrinking of the separator layers made of plastic material, and which form a thermal screen limiting the shrinking of the layers of the separator layers 26 and 27 made of plastic material of the elementary sequence(s) 17 in the event of heating the storage element 16.

Naturally, the invention is not limited to what has been described in the examples illustrated in FIGS. 3 and 4:
the number and configuration of the additional layers 29 and/or 30 could in particular not conform to what has been described. The additional layers 29 and/or 30 could for example comprise the same components, or a additional layer 29 or 30 could consist of a single electrode without a collector or of a single collector,
the additional layers 29 and/or 30 could be present only at one end 31 or 32 of the storage element 26,
the storage element 16 could be constituted differently, for example the electrode complexes 19 and/or 20 could comprise only one electrode, a collector being applied to it outside the pile,
the mechanical structure of the storage assembly 10 could be different from what has been described,
etc.

1. An energy storage assembly (10) including:
an electrical energy storage element (16) comprising at least one elementary cell (18) comprising a first and a second electrode complex (19, 20) stacked in a stacking direction (21), said elementary cell further comprising a first separator (26) made of plastic material extending between the first and the second electrode complex,
an external envelope (11) accommodating the storage element (16), the envelope including two distinct surfaces (15, 14) forming electrical terminals of the assembly having opposite polarity, the first complex(es) (19) being electrically connected to a first terminal (15) and the second complex(es) (20) being electrically connected to a second terminal (14), the assembly being characterized in that the element includes at least one additional layer (29, 30) extending to at least one end (31, 32) of the storage element in the stacking direction, each additional layer consisting of a component identical to one of the components (19, 20, 26, 27) of the elementary cell (18), none of the additional layers of a same end of the storage element being connected to the terminal of polarity opposite to the terminal to which the electrode complex adjoining said additional layers is connected.

2. The storage assembly according to claim 1, wherein the or at least one of the additional layers (29, 30) includes an electrode (22, 23).

3. The storage assembly according to any one of claims 1 and 2, wherein the or at least one of the elementary cells (18) is provided with at least one collector (24, 25) making it possible to connect an electrode complex (19, 20) of the cell to the corresponding terminal (15, 14), the or at least one of the additional layers (29, 30) including a collector (24, 25).

4. The storage assembly according to claims 2 and 3 in combination, wherein the or at least one of the additional layers (29, 30) is an electrode complex (19, 20) including at least one electrode (22, 23) and a collector (24, 25) in one single piece.

5. The storage assembly (16) according to any one of claims 1 to 4, wherein the or at least one of the additional layers (29, 30) includes a separator (26, 27) made of plastic material.

6. The storage assembly according to one of the previous claims, comprising at one of the ends (31, 32) at least, three adjoining additional layers (29) formed from two layers including an electrode between which is interposed a separator layer.

7. The storage assembly according to any one of claims 2 to 4 wherein, at one end of the element at least, at least one additional layer (29, 30) including an electrode is connected to the terminal of the same polarity as the electrode complex (19, 20) adjoining the additional layers of said end.

8. The storage assembly according to any one of the previous claims, wherein at least one additional layer (29, 30) of one of the ends (31, 32) is connected neither to the first nor to the second terminal (15, 14).

9. The storage assembly according to any one of the previous claims, wherein the components (19, 20, 26, 27) of the elementary cell(s) (18) form piled planar layers, the additional layer(s) (29, 30) being placed at one and/or the other of the ends (31, 32) of the pile.

10. The storage assembly according to any one of claims 1 to 8, wherein the components (19, 20, 26, 27) of the elementary cell(s) (18) are coiled up, so that the same component forms a plurality of layers of the coiling and the element (16) has a shape of a coil, the additional layer(s) (29, 30) being placed inside and/or outside the coiling.

11. The assembly according to claim 10, wherein the additional layer (29) located farthest within the coil is a layer including an electrode (22) and/or a collector (24).

12. The assembly according to any one of the previous claims, wherein at least one of the additional layers (29, 30) is made using a component (19, 20, 26, 27) also forming at least one layer of the or of at least one of the elementary cells (18).

13. A method for producing an electrical energy storage assembly (10), comprising the following steps of:
stacking a first electrode complex (19), a first separator (26) and a second electrode complex (20) in a stacking direction (21), so as to form an elementary cell (18);
constructing the storage element (16) based on at least one elementary cell (18) and at least one additional layer (29, 30) consisting of a component identical to one of the components of the elementary cell, so that the additional layer(s) are placed at the end (31, 32) of the storage element;
installing the storage element (16) in an external envelope (11) and connecting electrically the storage element to electrical terminals (14, 15) of opposite polarity of the storage assembly, formed by two distinct surfaces of the envelope, so that the first complex(es) (19) is(are) electrically connected to a first terminal (15) and the second complex(es) (20) is(are) connected to a second terminal (14), and none of the additional layers (29, 30) located at one end (31, 32) of the storage element is connected to the terminal of polarity opposite to the terminal of polarity to which the electrode complex adjoining said additional layers is connected.

14. The method according to claim 13, comprising the steps of:
stacking a second separator (27) on the second electrode complex (20) in the stacking direction (21), so as to form an elementary sequence (17);
coiling the elementary sequence around a coiling axis (28), so that the storage element (16) has the shape of a coil.

15. The method according to claim 14, wherein a portion of the components (19, 26) of the elementary sequence (17) is coiled alone around the coiling axis (28), so as to form a core of at least one additional layer (29) around which the elementary sequence is then coiled.

16. The method according to claim 15, wherein two components constituted by the first electrode complex (19) and the first separator (26) are coiled alone around the coiling axis (28), so as to form the core of at least one additional layer (29).

17. The method according to any one of claims 14 to 16, wherein a portion of the components (20, 27) of the elementary sequence (17) is coiled alone around the coiling axis (28) so as to wrap with at least one additional layer (30) the coil comprising the elementary sequence (17).

18. The method according to claim 17, wherein the second electrode complex (20) and the second separator (27) are coiled alone around the coiling axis (28) so as to wrap the coil with at least one additional layer (30).

19. The method according to claim 13, comprising the steps of:
stacking a second separator (27) on the second electrode complex (20) in a piling direction (35) coinciding with the stacking direction (21) so as to form an elementary sequence (17);
piling several elementary sequences in the piling direction;
piling at least one additional layer (29, 30) with at least one elementary sequence, so that the additional layer(s) (29, 30) is(are) located at one end (31, 32) at least of the pile previously formed in the piling direction.
